(19) United States
(12) Patent Application Publication
(10) Pub. No.: US 2006/0174352 A1
(43) Pub. Date: Aug. 3, 2006

(54) Method and apparatus for providing versatile services on storage devices

(75) Inventor: Robert Harwell Thibadeau, Pittsburgh, PA (US)

Correspondence Address: Robert P. Lenart;Pietragallo, Bosick & Gordon LLP, One Oxford Centre, 38th Floor, 301 Grant Street, Pittsburgh, PA, 15219, US

(73) Assignee: Seagate Technology LLC, Scotts Valley, CA (US)

(21) Appl. No.: 11/343,338

(22) Filed: Jan. 31, 2006

Related U.S. Application Data
(63) Continuation-in-part of application No. 11/178,908, filed on Jul. 11, 2005.
(63) Continuation-in-part of application No. 09/912,931, filed on Jul. 25, 2001, now Pat. No. 7,036,020.

(51) Int. Cl. H04L 9/32; G06F 12/14; G06F 17/30; G06F 7/04; G06F 11/30; G06K 9/00; H03M 1/68; H04K 1/00; H04L 9/00; H04N 7/16

(52) U.S. Cl. 726/27; 713/193

(57) ABSTRACT

An apparatus comprises a data storage device including a plurality of virtual smart cards in a plurality of security partitions, and a controller including a card operating system for controlling access to the smart cards.

### CROSS-REFERENCE TO RELATED APPLICATIONS

This application is a continuation-in-part application of U.S. patent application Ser. No. 09/912,931, filed Jul. 25, 2001, and U.S. patent application Ser. No. 11/178,908, filed Jul. 11, 2005, the disclosures of which are hereby incorporated by reference.

### FIELD OF THE INVENTION

The present invention generally relates to methods and apparatus for securing data in storage devices in computer systems.

### BACKGROUND OF THE INVENTION

With the advent and widespread deployment of the Internet, conventional computer security systems have been found to be deficient. A disadvantage of the Internet is that it permits many ways to infiltrate conventional computer system perimeter defense systems. Damaging virus programs, for example, can be injected through firewalls and into a computer system. This can compromise data and computer programs, and therefore derivative capabilities such as content protection and digital rights management.

This deficiency in computer system perimeter defenses creates the need to position security defense systems inside the local computer system. A conventional example of such localized computer system security is virus detection software. Virus detection software, however, can be susceptible to many exploits including, but not limited to, “spoofing” or “wrappering” strategies. Consequently, virus detection software may be made to appear operational when it is not properly operating.

Perhaps the greatest fundamental problem with conventional computer security systems is that their operation is common to the environment of the operating system environment. Furthermore, the operating system environment for many computer systems is also common to the Internet environment, for example, or another network communications medium. Because of this common environment, many means of attack on a computer system are available merely by moving computer code from the Internet to the computer operating system.

Some conventional methods of computer protection may involve special purpose security hardware or firmware installed in the BIOS of a computer system. These methods can establish secondary lines of defense internal to the operation of a computer system but external to the complicated and error-prone operating system environment. However, these methods often fail to recognize that a better line of defense could be realized with non-writeable firmware in the attached storage devices that provide the bulk of data and code storage for computer systems.

Other conventional computer security systems may include a security device connected to an SCSI bus that protects storage devices on the bus. This type of security system recognizes that the storage device is more secure while not operating in an environment common to the operating system. However, the SCSI bus of this system exposes all devices on the bus to access (including the storage devices), and therefore requires intimate operating systems involvement.

It would be an improvement over this technique to put the security measures in the attached storage firmware and hardware. The same solution could also then be applied in SCSI environments and other environments such as ATA storage device environments for hard disk drives, flash memory storage, optical storage, and tape storage devices.

Still other computer security systems recognize the benefit of guarding the storage device at the controller level but are based on shared private keys. Shared private keys are well-known to provide less security than securing and concealing elements of public-private key encryption, because authentication keys are shared and not private to a single device. This type of system is also directed to modification of the file management system of the computer operating system and therefore suffers the same problem of operating system dependence illustrated above for SCSI security. An improved computer security system could leave the operating system file management intact while maintaining separate control over security through a special security interface to the attached storage device.

In another type of computer security system, the security perimeter consists of self-contained software that exports only a simple storage interface for external access and verifies the integrity of each command before processing the command. By contrast, most file servers and client machines execute a multitude of services that are susceptible to attack. Since this self-securing storage device is a single-function device, the task of making it secure is made easier. However, the objective of this system is to provide for automated recovery to a known good state relying on the previous secure storage mechanisms. This type of system also requires operating systems modification. It incorporates complexity, and therefore vulnerability, approaching that of an operating system, and permits opportunities for the introduction of Trojan code, for example, into the system. Furthermore, this type of system does not recognize the improved security afforded by using the storage device for hiding and securing public-private key operations.

Security afforded to a computer system by the ATA Host Protected Area security protocol can be provided by a method used in connection with readying a storage device during the boot phase of a computer system. In this method, the storage device can be declared to the operating system to have less storage space than the storage device actually has ready for use by the operating system. Special BIOS firmware or other special code can have exclusive access to the undeclared portion of storage space. As an additional security measure, the ATA Host Protected Area can require passcode access to this additional amount of storage space. The ATA Host Protected Area was originally designed to provide security assurance in the form of enhanced operating system and application crash recovery efficiencies. A known good version of the system or application software could be cached in a location outside the capability of the operating system to address. In practice, this restricts access to a portion of the storage device to a computer program running either in the main device firmware or in the operating system environment.

A problem with the ATA Host Protected Area protocol is that it is still possible to intercept communications with the storage device that contains critical information. The hidden ATA Host Protected Area partition of the storage device can be revealed, for example, by putting that same disc drive into another computer that does not reserve the Host Protected Area space. The passcode, if used, is not retained across power cycles. The ATA Host Protected Area, in practice, is an acceptable place to protect local backup code and data from virus-like infections but is typically not the best place to conceal data. Furthermore, the only authentication required by the ATA Host Protected Area is a “first come first served, winner take all” type of device authentication. Public-private key techniques applied to sections of secure data storage would provide an improvement in this type of security.

Most modern storage devices are embedded controller storage devices and therefore have at minimum four component parts: a well-defined communications interface, a processor, random access electronic memory for enabling the processor and buffering data, and a core storage medium (such as rotating disc storage or flash memory). An interface between the storage device and the host system has a well-defined interface protocol such as INCITS T13 ATA or INCITS T10 SCSI through which the embedded controller storage device provides a fixed set of services to the host.

The most common services provided to the host are writing and reading blocks of data on the core storage medium. Since the inception of embedded controller storage devices, they have provided other well-defined services to the host. For example, one well-known service in ATA is a password security service supported by the BIOS on the platform host. Interface commands are defined that allow a password and a master password to be provided to secure the use of the storage device. During host booting and consequent drive initialization and booting, the drive will not perform its basic read/write function until the password or master password is provided over the interface. Another well-known command is a drive erase command that instructs the processor on the drive to erase the entire disc.

While these services provide some data security, a need remains for a method and apparatus that can provide improved secure services from the storage device.

### SUMMARY OF THE INVENTION

This invention provides an apparatus comprising a data storage device including a plurality of virtual smart cards in a plurality of security partitions, and a controller including a card operating system for controlling access to the smart cards.

### BRIEF DESCRIPTION OF THE DRAWINGS

FIG. 1 is a diagram showing a system that can be used to implement methods and apparatus for promoting computer security.

FIG. 2 is a block diagram showing details of the storage device of FIG. 1.

FIG. 3 is a schematic representation of the interaction between a storage device and an operating system of a computer system.

FIG. 4 is a schematic representation of the details of the authority records and security partition data shown in FIG. 3.

FIG. 5 is a block diagram of a computer system that includes an embodiment of the invention.

FIG. 6 is a block diagram of a card operating system and associated interfaces.

FIG. 7 is a block diagram of a card operating system and several virtual smart cards.

FIG. 8 is a more detailed block diagram of a card operating system and several virtual smart cards.

FIG. 9 is a block diagram that illustrates the operation of the virtual smart cards.

FIG. 10 is a block diagram that illustrates the issuance of the virtual smart cards.

### DETAILED DESCRIPTION OF THE INVENTION

As used herein, “computer systems” include, but are not limited to, desktop computer systems, laptop computer systems, networked computer systems, wireless systems such as cellular phones and PDA's, digital cameras including self-contained web-cams, and/or any reasonable combination of these systems and devices.

As used herein, the terms “storage device” and “disc drive” or “disc” are interchangeable, except where otherwise noted, and include any device for persistent storage of data in a computer system in accordance with the computer security methods and apparatus discussed herein. Notwithstanding the use of the term “disc”, the storage device need not necessarily incorporate a physical “disc” but preferably incorporates a storage medium or device managed by a controller with firmware.

It can be appreciated that the term “partition” is used in certain embodiments herein to mean a contiguous grouping of bytes as allocated by the low-level formatting of the storage device.

Special security partitions and the structures and processes that support these security partitions are included in the present computer security methods and apparatus. The methods and apparatus of this invention provide a security system that is substantially not dependent on the host operating system.

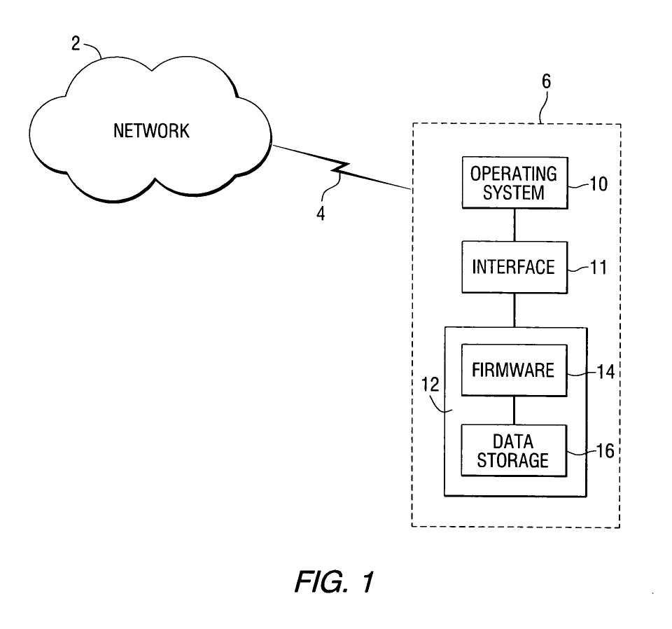

Referring now to FIG. 1, the architecture of a system consistent with the methods and apparatus discussed hereinafter is shown. The network 2, which can be the Internet or another network communications medium, is connected by a wireless or wired (not shown) connection 4 to the computer system 6 of a user. Inside of the computer system 6 is an operating system 10, which relies at least in part on software and data obtained from a storage device 12. The operating system communicates with the storage device through an interface 11, such as an ATA or SCSI interface.

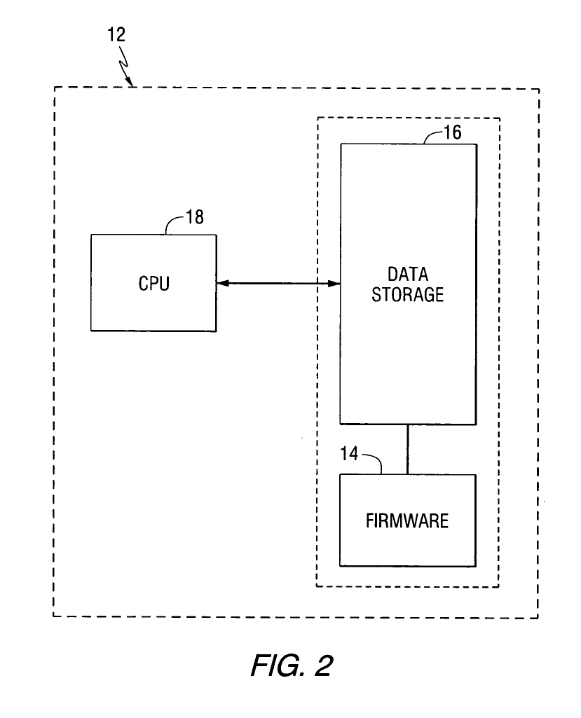

Referring now to FIGS. 1 and 2, a more detailed schematic of the storage device 12 is shown in FIG. 1. The storage device 12 contains firmware 14 that reads and writes data from a data storage portion 16 of the storage device 12. It can be appreciated that at least a portion of the storage device firmware 14 can be rewritten by software executed in the operating system 10. This portion of the storage device firmware 14 that can be written can be considered writeable firmware (“WF”). In contrast, at least a portion of the storage device firmware 14 is written by using one or more of a plurality of conventional hardware methods that prevent this firmware from being written by the operating system 10. This portion of the storage device firmware 14 that cannot be written can be considered non-writeable firmware (“NWF”). In one embodiment, the storage device 12 can also include a separate central processing unit 18 (“CPU”) for accessing and otherwise manipulating data in the data storage portion 16 of the storage device 12. It can be made a requirement that no data can be transported to or from the data storage portion 16 of the storage device 12, except in connection with execution of the NWF or WF.

For purposes of illustration, some examples of NWF and WF firmware can be derived in connection with the ATA and SCSI disc controller protocols. At least portions of these protocols relate to connectivity between the operating system and the data storage components of a computer system. The ATA protocol, for example, permits customization of commands, such as controller commands, by a user. In one embodiment, the present computer security methods and apparatus offer an addition to the ATA/ATAPI-5 ANSI specification, NCITS 340-2000. However, it can be appreciated that parallel, analogous additions can be made by the methods and apparatus addressed herein to the SCSI specification and other suitable disc controller specifications that allow, for example, vendor-specific or standards-driven extensions. It can also be understood that the methods and apparatus discussed herein can form the basis for a component part of a new disc controller specification.

Data storage, as applied herein, can be provided in connection with a conventional disc controller protocol such as ATA or SCSI. One type of security protocol available to ATA, in particular, is known to those skilled in the art as ATA Host Protected Area. Mapped-out storage, as applied herein, is storage space that is mapped-out by tables in the NWF and WF to indicate bad sectors. It is understood that other data can be mapped-out of the writeable storage by the disc controller for the storage device.

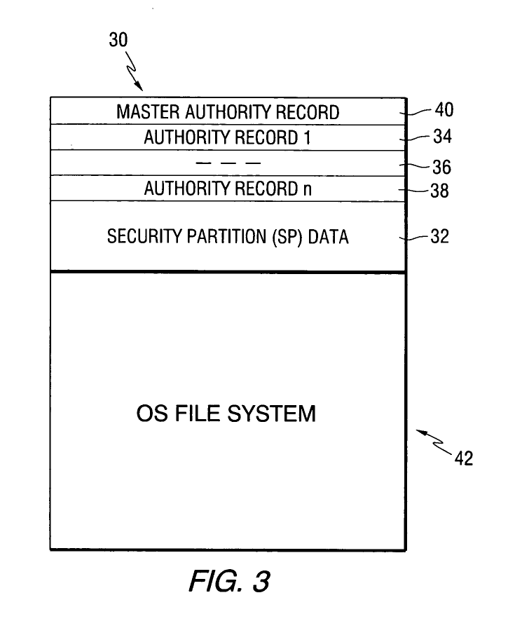

Referring now to FIG. 3, the present computer security methods and apparatus can augment existing ATA and SCSI protocols, for example, with simple and effective enhanced security protocols. The methods and apparatus include a storage device 30 having a plurality of security partitions (“SP”), only one of which is shown in FIG. 3. Each security partition contains data 32 and at least one authority record, such as authority record 34, associated with the security partition data 32. These security partition data 34 and authority records 34, 36, 38 are contained in a security partition of the storage device 30. The present methods and apparatus provide a relatively simple file system located on the low-level formatting of the storage device 30. The growth of data added to each security partition of the storage device 30 proceeds from top to bottom, as shown in FIG. 3, so that a query of the storage device 30 contents can readily reveal how much data storage space remains for use.

Operations involving the authority records 34, 36, 38 are managed by the firmware of the storage device 30. In one embodiment, all authority records 34, 36 and 38 can be governed by a single master authority record 40. As shown, a host operating system (“OS”) 42 is not permitted to access the security partition data 32 contained in the storage device 30. This independence of the security partition data 32 from the host OS 42 provides an important benefit of the present invention security methods and apparatus: to create a location on a computer system where information such as a secret can be effectively concealed.

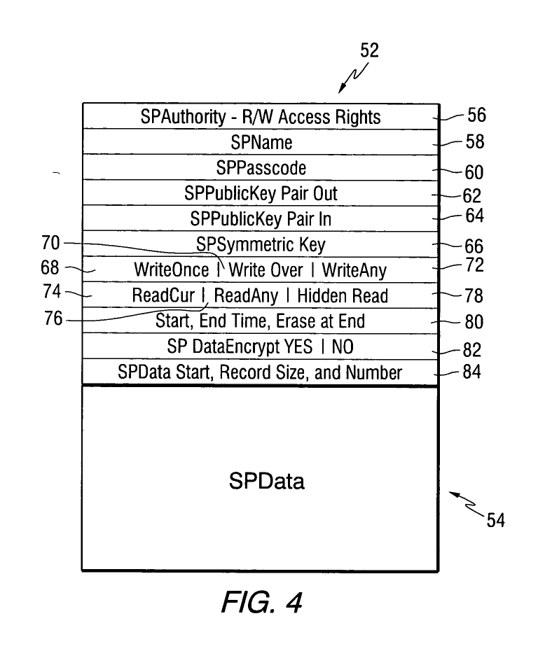

Referring now to FIG. 4, a schematic representation of an authority record 52 is presented in accordance with the authority records 34, 36, and 38 of FIG. 3. The authority record 52 can include data, computer programs, and other like information and functionality in association with the SP data 54 corresponding to the authority record 52. The contents of the authority record 52 and the SP data 54 (elements 56 through 84) are related to information for which concealment is desired and/or functionality that promotes secure data processing in a computer system. Types of information that can be stored in SP data 54 and types of secure processing functions performed by the authority record 52 in connection with the SP data 54, as indicated in elements 56 through 84, are presented below as examples.

It can be seen that there are many advantages to a closed, non-expandable, storage and authority system as described herein. The storage device can define, for certain data on the disc, a structure for authorization and authentication that can be readily inspected and audited. If authorization and authentication functions are not provided in a closed system, then a computer system is generally more vulnerable to attack and infiltration. It can be appreciated that 63 user-definable authority records and one master record are likely to suffice for most practical applications of the present computer security methods and apparatus. Because these methods and apparatus are storage device specific lines of security defense, a single authority can translate to a group authority in the operating system environment or an entire domain authority. Since the authorities can be created and deleted by the user as needed, with the understanding that a master authority record can govern these user modifications, the present methods and apparatus provide an appropriate line of defense for the computer system.

It can be appreciated that the following examples are intended primarily for purposes of illustration. No particular aspect or aspects of the method and apparatus embodiments described herein are intended to limit the scope of the present invention. For example, it can be appreciated that a particular choice of nomenclature for security partition commands executed by the present computer security methods and apparatus are for illustration purposes and are not intended to limit the scope of the present invention.

As applied to the present computer security methods and apparatus, reading and writing data to a secured data partition can use conventional read/write mechanisms and protocols. In one aspect, if a read or write of a security partition is attempted, the security partition can be opened using a security partition open call, such as the SPOpen command. Once open, the security partition remains open until closed (such as by use of the SPClose command) or until expiration of a predetermined time interval. An SPOpen command can limit read and write access in many ways that are important to security functions needed for the storage device. In another embodiment, specialized SP, fixed-length and record-oriented, read and write operations are permitted that do not leave open the windows of opportunity that the global SPOpen command can permit.

In some embodiments, the SPOpen and SPClose commands are not available due to security or efficiency considerations and read and write operations are performed through the available SPProtRead and SPProtWrite commands. Use of the SPProtRead and SPProtWrite commands can perform an internal, hidden, SPOpen functionally equivalent action without exposing the secure data to user interaction.

In certain embodiments, the present computer security methods and apparatus can use, for example, ANSI X.509 certificates that can employ trap-door cryptographic algorithms such as the well-known RSA algorithm for authentication. Each authority record can contain one public-private key pair for authenticating data that originates from the security partition of interest. A second public-private key pair is provided to ensure that data can only be sent to the particular security partition and no other location for storage. These key pairs are associated with X.509 Cert-In (i.e., the data are only transmitted to the desired partition) and X.509 Cert-Out (the data are signed and thereby authenticated to come only from the desired partition). A symmetric key can be used in a way substantially similar to SSL and other equivalently secure streaming protocols to encrypt the data. In this embodiment, the public-private keys are used primarily for the hashes associated with the certificates, although a private key can decode a passcode directed to an authority.

The methods and apparatus described herein can require that the above-mentioned cryptographic operations are embedded in the firmware or physical storage of the storage device. The cryptographic code is authenticated with a root assurance in the NWF of the device. In this manner, access to reading or writing SP-protected data cannot be susceptible to attack except by physically modifying the storage device. The SP system also provides for encrypting data in the data partition. The encryption utilizes the symmetric key. If encryption is turned off, then the data in the storage device are plain text even though the symmetric encryption may not have been employed in transmitting the data to and from its storage location. If encryption is turned on, then the data in the storage device are encrypted even though the symmetric encryption may not have been employed in transmitting the data to and from its storage location.

If the SP data are encrypted and the authority source is external, a method and apparatus can be provided to encrypt data on the storage device so that only an external agent can decrypt the data. The SP DataEncrypt command encrypts the SP data so that a key can be acquired and applied from an external source.

In this example, there is no accessible method for decrypting the data from the storage device based on information available in the storage device. This method and apparatus involves securely transmitting the public key and symmetric key. The private key is provided to decrypt the symmetric key when the symmetric key is needed for use in encrypting or decrypting data. This public key/symmetric key/private key arrangement is a conventional method for providing file encryption. The present computer security methods and apparatus improve this conventional method by providing for security methods and apparatus contained only in the storage device and not as part of an operating system or file system.

Another feature of the authority record that controls the reading and writing of data in a security partition is that certain fields of the authority record can be hidden. “Hidden” typically means that the values in these fields cannot be read by any external process, i.e., the values cannot be read either by a call to the firmware or by direct examination of the contents of the storage device. There are a plurality of known hardware techniques by which storage can be protected: for example, mapping out the address space of such storage except to the NWF. Another technique that can be applied in connection with the passcode field of the authority record is to store only a hash of code. This technique is possible because there is no requirement to read a plain text passcode. In addition, another technique is to hide a symmetric key by encrypting the key with an authority's public key, such that only the hidden private key can decode it.

In practice of the present computer security methods and apparatus, a distinction can be made between an external authority source and an internal authority source. If a security partition is an internal authority source, then the public-private key pairs and symmetric keys are generated internally by the NWF and WF of the storage device. If a security partition is an external authority source, then the public-private key pairs and the symmetric key can be transmitted by a secure method of transmission (as defined by the SPCSet command, for example) to the storage device. This means that while certain data, such as a private key, can be written (such as by the SPCSet or by the internal key generator), the data are not read by any external process, because they are defined as hidden. It is important that the same “Write but Not Read” capability can be afforded data in any security partition that is a “Write but Not (external) Read” partition. Therefore, a user application external to the storage device can employ the storage device as a reliable place to conceal information and to perform cryptographic operations with a relatively high degree of security and secrecy.

One embodiment of the present computer security methods and apparatus provides for declaring SP data to be write-once. One illustrative use of this embodiment is in PKI (public key infrastructure), wherein a problem exists in validating public keys for a particular authority. The security partition of the present methods and apparatus can verify the source of the public key dynamically. This overcomes one of the fundamental problems in PKI known as key revocation. It is possible with the present methods and apparatus to have a secure means of dynamically keeping public keys current with a relatively high level of assurance. Another application of the write-once embodiment is applied to lock software to a system or disc and create logs that cannot be repudiated or accessed without authorization. In this embodiment, the storage device can be employed to read the log, which may contain credit card purchase information, for example.

The present computer security embodiments typically use a fixed amount of space associated with each authority record and associated data set. In addition, one master authority record can contain the authority records for all other security partitions. For example, each authority record can use 2633 bytes of a six block (3072 byte) region, and there can be 64 possible authority records, for a total of 196,608 bytes in the security partition which contains the authority records for all security partitions. In this illustrative system, there can only be 63 user-definable security partitions. No external authority is permitted access in this embodiment except as defined by the external source of private/public/symmetric keys. This means that only an authority record defined on the storage device can be an authority permitted to read or write any other authority record and/or data set. It can be appreciated that an allowance is made in the publicly-readable, and typically factory-set, authority record header to expand or reduce this closed system of authority to more than or less than 64 total authority records.

In embodiments of the present computer security systems that maintain a finite number of authority records with a fixed-space utilization for the master authority record, the performance penalty associated with having an SP-enabled storage device can be regulated. In general, any read or write operation on the storage device checks to determine whether low-level storage addresses (e.g., cylinder, head, sector, block and the like) are protected by a security partition.

In another embodiment, the security partition region is modeled like an ATA Host Protected Area region. The partition containing the master authority record and the other authority records has a known, fixed size and uses storage hidden even from an ATA Host Protected Area call. Any partitions below the master authority record can use the top portion of the ATA Host Protected Area space. Since write and read operations in the ATA Host Protected Area space are typically rare, it can be effective to add a function to check for SP-protected regions.

In another aspect of the present methods and apparatus, an SPAuthHeader call returns a list of protected disc address regions. By designating a fixed region of the storage device to be the area where SP data resides, the function of checking for permitted write operations can be performed. The SPAuthHeader call returns values synthesized and stored in the extended authority partition header. It is useful for this call to report contiguous regions of the storage device that are SP-protected. In this manner, user software can be warned not to attempt to address those regions without appropriate SPOpen calls. An SPAuthHeader call may not report disc addresses to which a user does not have access.

It can be appreciated that a user-defined SP data partition can consume the entire storage capacity of the storage device if such consumption is permitted by the NWF and WF. This is one reason for restricting authority to read and write the master authority record to only predetermined users. The present system can provide authentication of these predetermined users and minimize the number of users who have administrator-level control over the authority records.

An important function of the SPAuthHeader call is to return the public key for communicating to the master authority record. This function is important because the master authority record requires public key encryption for the passcode needed to access the master authority record. A factory distributed storage device can have a passcode structured so that software attempting to initialize the master authority record must know the passcode. The passcode is also structured so that it cannot be “sniffed” or otherwise inspected in transit because of the passcode's encryption with the master authority record's public key.

It is known that publishing a public key for encrypting passcodes can make use of the public key susceptible to a replay attack. To resist such attacks, one embodiment of the present security methods and apparatus includes SPNonce (which contains a “nonce”) and SPAuthNonce fields in the authority record and the authority header. The nonce can be a random number up to 256 bytes in length that is intended for one-time use. In one embodiment, the nonce is encrypted with the public key as a portion of the passcode. This ensures that the sender of the passcode knows the passcode. The nonce is made a part of the authority record so that the nonce can be passed to the NWF and WF. This permits the nonce to be used to gain authority to remote storage devices through passcodes that are stored and hidden in user authority records.

For generation of keys and nonces, a random number generator can be provided in the NWF and WF. Certain storage devices, such as hard disks, afford opportunities for measuring random mechanical or electronic error that can be cultivated as a source for random numbers. The present computer security methods and apparatus can use this continuous random number, for example, with secure storage-to-storage transmission to create one-time pads. One-time pads are well-known perfect encryption-decryption techniques.

It can be appreciated that since an authority record can have SP data that have start times, end times, and/or instructions to remove or transfer SP data at a predetermined time, then a reliable source for clock time is needed. Benefit can be obtained by having a clock inside the storage device that can be synchronized to an external clock through a secure authorized transmission. This necessitates an additional call that has an authority record set aside or that needs use of the master authority record. By reducing the amount of time the nonce is considered to be valid, then the error in the transmitted clock time can be bounded.

A common use of a secure partition is to store the public keys of other secure partitions on other devices. In this embodiment, a secure network of storage devices can be achieved, because the passcodes that permit access to other authority records on other devices are themselves encrypted inside the storage devices. For example, it is possible to create one or more master registries that can securely manage the security partitions on a number of other storage devices.

It can be appreciated that the present computer security embodiments must deal with call authentication to secure code and data in the operating system environment. Call authentication has two general cases. In one case, it is necessary to authenticate that a computer program, for example, that is called is the correct computer program. In the other case, it is necessary to authenticate that the program or routine that calls the computer program is the correct program or routine.

Call authentication provides the basis for secure communications between code running in the operating system and the storage device authority. The general case for the operating system is to have a plurality of loader/linkers. These are operating system programs that read code from storage; assign symbolic, virtual and physical addresses; initialize values; load the code into execution memory; and can also initiate code execution.

A conventional practice is to put code authentication in the loader/linker. However, once legitimate code is authenticated, loaded and linked, intrusive code can modify the legitimate code during execution. Introduction of intrusive code can be readily performed if the code that is linked and loaded can read data from the storage device and interpret that data as a program code. Many programs have the capacity to introduce intrusive code accidentally in this manner. However, even without this capacity, there are schemes such as a conventional buffer-overflow exploit that can replace code known to be authentic with intrusive code.

Code authentication is nevertheless useful at the loader/linker level. If all reads of data that are to function as code are authenticated reads, then much of the benefit of code authentication can be realized. If buffer-overflow and similar exploits are eliminated through good programming practice, then code authentication can be an effective technique. It is well-known, however, that code running in an open operating system environment often fails to conform to good security practices.

The present computer security methods and apparatus can provide a component for code authentication. In one embodiment, one or more authority records can be employed by one or more loader/linkers to store public keys as data and check the code being loaded for authenticity. The loader/linker can therefore be certain that the public key, the hash value, and the code are authentic. The loader/linker code can be stored in non-writeable space in one authority record to ensure that its essential code is unaffected.

Code authentication can handle the call authentication problem only if all calls are made to properly authenticated code. There remains a possibility that intrusive data can be introduced that cause a call to an incorrect code segment. In an operating system where communication is defined through message passing or similar object-oriented methods, calling is done by name or handle. The authority record can be employed in a “write-once-no-delete” mode to record authenticated calls between code segments. If all code segments are authenticated, then they are coded typically to proper bound-checking standards. In this case, the call-path is authenticated and is unlikely to have a security breach.

Another method for providing call authentication involves the well-known principle of wrappering code segments. In this method, a code segment is executed within the memory space of another code segment that has been introduced either by the code compiler or the loader/linker. An example of this is the debugging function in a conventional compiler. Another example is in interpreted byte code systems. Assuming that the wrappering code is available directly from protected disc authority space, then it can provide for fully call authenticated action by a code module. The method confirms that calls external to the code are calls to the symbolic, virtual, or physical addresses originally authenticated. For example, if a code set should not open a port to the Internet, then the wrapper provides an alarm if such a port opening was attempted. The data that records the calls permitted within the wrapper are preferably stored in a secure, non-writeable authority record.

The general solution to call authentication within the present computer security methods and apparatus employs the storage device to store authentication data; to perform the authentication computation; and to store special code segments from which roots of trust in the operating system environment can be established. In general, key loader/linkers and code interpreters are sufficient to establish trust on particular code operating within the operating system environment. This is an improvement over other approaches that propose radically altering the file system or securing the entire operating system environment when that environment cannot usually be completely secured. The present computer security embodiments provide key tools that can be employed to secure code execution within the operating system environment and therefore provide a scaleable solution to the call authentication problem.

The methods and apparatus discussed herein provide significant improvements and advantages for promoting computer system security. Internal security is provided for a computer system that uses a local or remote storage device for program and data. The storage device can be one or more storage devices that can reside in a single computer system. The computer systems can be connected by a bus or a network.

The computer system is protected from network-originated attacks, particularly where the computer system relies on storage devices. Data and computer programs are protected against unauthorized use and copying within a computer device and/or system. The storage device can secure and conceal private keys, and also sign and check messages in a hidden but authenticated manner.

Existing computer security systems in a local area or wide area enterprise that depends on electronic or electro-optic data and computer programs can be easily updated. Data and computer programs can be transmitted to a storage device through broadband and/or narrowband unswitched and/or switched networks, so that an indication of the secure and accurate function of the data and/or computer programs in the computer system can be provided.

The apparatus provides a means for transmitting, storing and managing public keys for a public key infrastructure and private keys for cryptographic use. The integrity and rights of multimedia audio and video content can be managed across many storage devices in both local areas and wide areas. Storage security is provided without hampering storage device performance in normal use.

The invention provides improved use of the ANSI ATA-4 and ATA-5 Host Protected Area. It also provides assurance to the operation and integrity of an operating system across a plurality of networked computer systems; an applications system in a computer system; an applications system across a plurality of networked computer systems; a backup and recovery system in a computer system; and a backup and recovery system across a plurality of networked computerized systems. In addition, the invention permits the creation and use of one-time pad cryptography between and/or among a plurality of storage devices and/or computer systems.

The present invention provides improvements to the methods and apparatus described by first providing for multiple security partitions on a single storage device and each using virtual interfaces associated with smart cards. As used herein, a smart card is an integrated chip security device capable of protecting data. As used herein a virtual interface uses smart card commands, which are compliant with a smart card standard such as for example ISO-7816, to provide one embodiment of the described methods and apparatus. The combination of a virtual interface with the functionality of traditional smart cards results in virtual smart cards used in this invention. Thus virtual smart cards can be implemented using firmware in multiple SPs.

Each protected partition can be protected using versatile, programmable, protections well-known for traditional smart cards as illustrated by the ISO-7816 standard. Smart card commands are similar to storage device commands in that the host initiates the command and the device responds. The original ISO standards instruct that smart card commands can be sent over an ATA interface. ATA commands exist that can provide containers for smart card and other commands.

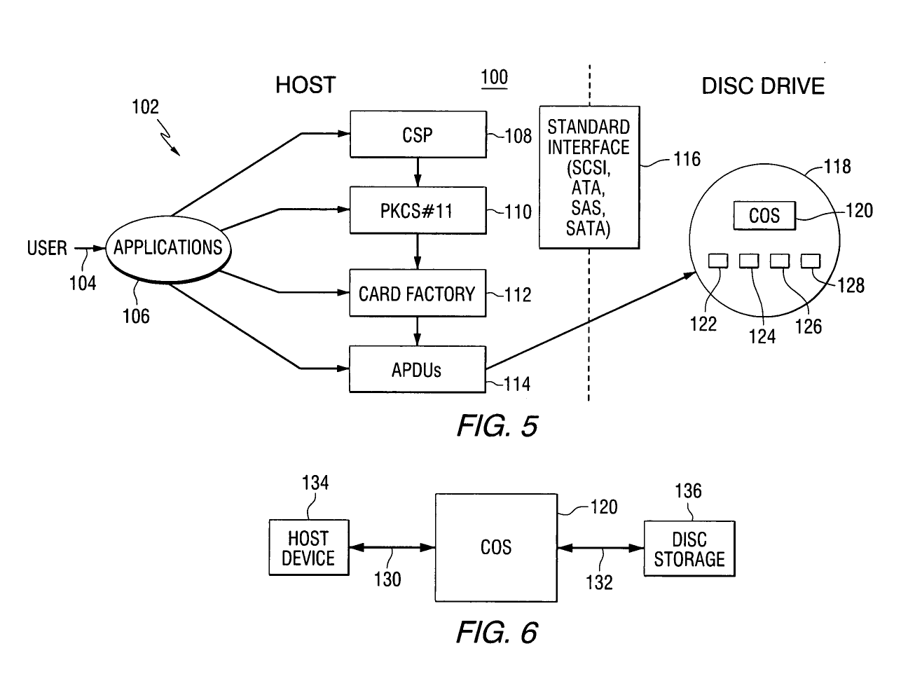

FIG. 5 is a block diagram of a system 100 that includes a storage device constructed in accordance with an embodiment of the present invention. The system includes a host computer 102 including a user interface 104. The host contains a plurality of applications 106. The applications can operate using one or more security techniques or devices, for example CSP 108, PKCS#11 110, or factory cards 112. The applications produce Application Protocol Data Units or APDUs as shown in block 114. The APDUs are transmitted through a standard interface 116, such as for example SCSI, ATA, SAS or SATA, to a storage device 118.

The storage device includes a card operating system 120, and a plurality of virtual smart cards 122, 124, 126 and 128, located in security partitions of a disc or other storage means, such as flash memory. The present invention encapsulates the ISO-7816 smart card interface within ATA or SCSI commands to provide improved smart card services from the storage device. The multiple independent virtual smart cards in the storage device individually correspond to security partitions described above.

One of the virtual smart cards can provide an administration smart card interface that corresponds to the administration security partition described above.

The storage device can be referred to as a trusted drive. A single trusted drive can offer a plurality of hardware security tokens based on well-accepted standards that are independent of the disc drive interface to its host. These hardware security tokens include a Microsoft CSP which supports key protection for the Microsoft Windows security model, PKCS#11 Cryptoki which supports key protection for the Java, Unix, Linux, Macintosh, Sun, and IBM security models, and, finally, the ISO/ANSI 7816 Smart Card which supports key protection and a security file system in a wide range of applications, from user authentication, device authentication, digital rights management, privacy rights management, telephonic/mobile security, eCommerce, and numerous commercial and national, security, and privacy infrastructures. As such, a trusted drive offers a protected means for security and privacy policy enforcement. The security level of the trusted drive reduces security risk from host and network attacks, on desktops, notebooks, and other host platforms.

In one embodiment of the invention, the storage device is a disc drive. A modern disc drive has one or more powerful microprocessors on board that gate all information transfer to and from the media of the disc drive. In addition, the interface, whether it be an ATA Interface, SCSI, Fiber Channel, USB, or Firewire, is a secure, restricted, communication channel, unlike Internet TCP/IP. Therefore, a drive can act as a hardware security token for the devices to which it is attached. It can offload sensitive computation, such as password checking and private cryptographic key operations, and it can hide large quantities of structured information from unauthorized use.

The trusted drive provides a well-recognized and widely used set of security services to the drive's host machine. A plurality of individual and distinct security service providers, called security partitions (SPs) are provided on the drive. Because the system is based on smart card firmware, these SPs contain virtual smart cards.

Any SP can be invoked to provide the following set of security services that are already in use in tens of millions of software applications worldwide:

1. A Microsoft Cryptographic Service Provider (CSP) that supplies key management services to Windows 2000+ for a diverse assortment of Windows functions including Windows Logon, File Encryption, Internet Browser security, and Virtual Private Networking (IPSec support).

2. An RSA PKCS#11 Cryptoki that supplies similar key management services in other product spaces such as Netscape, Java, Sun Solaris, Apple OS X, and Linux.

3. A GSC-IS 2.1 File System (U.S. Government Smart Card) compliant ISO 7816 Smart Card that, in addition to providing similar key management services, also exposes an industry standard secure file system that is completely hidden from the normal file system running on the Host Operating Systems (Windows, Linux, Apple OS X, Sun, etc.) The cryptographic library includes RSA 1024 Public Key including key pair generation, 3DES symmetric key encryption, and SHA-1 Hashing. ISO 7816 smart card technology is a well-known and well-utilized technology with over a billion cards in current use in mobile phones and satellite TV set tops, and with growing deployment in notebook, desktop, and enterprise computing platforms.

The drive can employ enhanced smart card firmware in order to deliver the above services to the host. This provides enhancements that include technology to support multiple virtual smart cards operating on a disc drive. This technology includes the capability to address different cards, manage their issuance, suspension, and removal, as well as the technology to insure that the cards are reliably kept on the media in a way that is fully hidden from host and network software attack vectors. One embodiment of the invention can support ISO 7816 Record Files and Cyclic Files, as well as the Binary File type mandated by GSC.

A fully general ‘tag-length-value’ (ISO TLV) interpretation for the SP data permits complex commands to be passed between the host and the drive while not deviating from the ISO 7816 specification. In addition, various other smart card commands taken from other well-known smart card interoperability standards can be included to enhance and round out the basic functionality of the GSC smart card.

An ISO 7816 compliant mechanism is provided for extending the size of an individual smart card from a default 32 Kilobytes of hidden storage, up to the limit of the factory-set hidden space, which may be many gigabytes. The user may create extended files in the file system that have arbitrary size. This mechanism for extending smart card size can be set on card issuance and does not require special factory configuration.

Many thousands of applications written by hundreds of companies worldwide are known and in current use for traditional smart cards, CSPs, and Cryptokis. In ordinary use, a single smart card will have very simple functionality. A very common function is hiding a cryptographic key that will authenticate a user logon that is based on a password that is more memorable than the key.

The purpose of providing many virtual smart cards on a drive, as opposed to just one, is to support many applications from many sources that may be running on a single host or in a network enterprise management environment. On LANs and WANs different software systems interplay. The SPs provide security services that are operating system independent and are well recognized by all major host operating systems.

The GSC version of a traditional smart card is open, non-proprietary, and offers an interoperable file system. File systems on all versions of traditional smart cards conform to the ISO 7816 standard, but this standard is subject to interpretation and widespread incompatibilities in accessing and manipulating the ISO 7816 defined file system. GSC-IS 2.1 rectifies this and is unique among ISO-7816 smart card standards in unambiguously defining access and manipulation of the file system on a card.

Key management can be handled through the industry standard PKCS#15 file subsystem in a smart card file system. PKCS#15 standardizes public and private key references, certificate storage, and ties these to the commands that manipulate these keys.

The components of the architecture of FIG. 5 include a host side software stack designed to expose the SP virtual smart cards in the standard environment in which hardware cryptographic tokens are employed. The drive manufacturer would supply the software needed to interface into these standard environments. In an embodiment of the invention, a Card Operating System (COS) is included on the storage controller and provides access to the various SP virtual smart cards on the drive. An Administrative SP virtual smart card and the CSP (or PKCS#11) can be factory installed. The remainder must be issued using a Card Issuance Protocol.

Every drive has one Administrative SP (Admin SP) that is issued in the factory. It also optionally has one User SP issued at the factory that is available as a MS CSP or a PKCS#11 Cryptoki with unrestricted access by the host. This unrestricted access by the host cannot be altered and is therefore congruent with a Default CSP that is used on the host operating system. In cases where the intention is to provide protection against host attacks, other virtual smart cards can be expressly issued using the Card Issuance protocols.

Additional User SPs may be created, suspended, or removed by commands reserved only for the Admin SP in the Card Issuance Protocols. The Admin SP may also be queried for status and other bookkeeping information about all the SPs issued on the drive. The Admin SP is not available as a MS CSP or a PKCS#11 Cryptoki, but only as a virtual smart card that has conventional User Card commands as well as the special protocol and status commands reserved for it.

It is important to recognize that the MS CSP and the PKCS#11 Cryptoki do not provide a file system or, for that matter, much other than a key store. Only through the virtual smart card interface does the user gain access to a protected hidden file system on the drive. The protections include customizable access control lists on every directory, file, and command on the virtual smart card SP.

The virtual smart card commands may be organized by the standard from which they are taken. Literally billions of traditional smart cards have been manufactured and well over a billion are in current use. There are a number of traditional smart card standards bodies in existence. These standards bodies include:

1. ISO: International Standards Organization of the United Nations. This is the body that issued the basic specification known as 7816 and continues to be active in follow on specifications.

2. ETSI: European Telecommunications Standards Institute. This group has focused on extensions to ISO 7816 pertinent to phone smart cards.

3. NIST: National Institutes of Standards and Technology. This group has focused on the GSC or “Government Smart Card” standard that has committed to an interoperable file system standard under ISO 7816.

4. Global Platform: Originally JavaCard, this is an independent group that has focused on advanced interoperable smart card architectures based on ISO 7816.

Since all smart cards are 7816 compliant at their root, a brief digression on 7816 smart card operation is in order. The file system is the familiar hierarchical file system, with a root directory, and subdirectories. In any directory there are one or more files that contain data. It is also possible to mark a file as just containing data or as being an executable program or other special type of file. The data files may be a collection of bytes with a cursor at a current position, a collection of records of bytes with a cursor at a record position, or a cyclical collection of records where the cursor circles in the file. In the terminology of the standards, a file is called an Elementary File or EF, and a directory is called a Directory File, or DF. The root directory of a smart card file system is called an MF or Master File.

The commands sent to a smart card are simple commands to execute a pre-programmed action and return a result. They are similar to ATA commands in this regard, although their content is very different. The basic command structure is to issue a command to move to a location in the file system and then do something at that location. Moving is done with the SELECT command. The things that can be done include reading and writing data and also performing specialized and custom commands.

Associated with every file (EF, DF, or MF) is an access control list, which may be configured as an acceptable embodiment of the present methods and apparatus. This access control list specifies the conditions under which the various permitted actions may be authorized on the file. Actions such as reading or writing data will not be permitted if the access control conditions are not satisfied. Access control conditions include no limitation on access, access requiring a PIN (or Password), and access requiring cryptographic proof. When cryptographic proof is required, it may be either symmetric key proof (such as 3DES proof) or public key proof (such as RSA 1024). In these cases the smart card can provide an embodiment of the present methods and apparatus and can provide strong security.

If it is desired to first authenticate the agent getting the session key, this can be done with a few more script statements that reference a public key already known for that agent or known through a public key chain.

The COS supports the ISO Standard Binary, Record, and Cyclic file types for data files, and two executable file types: the scripting language file type and a native code executable file type.

There are two extensions for large virtual smart cards. In the first, the addressing of the virtual smart card system is extended from two-byte addressing that effectively limit card sizes to 65 KB to four-byte addressing that brings card sizes up to 4 GB. While this is a feature of the COS, it must be set in the factory and there are certain issues in the current buffer management software that would have to be overcome.

The second extension uses another ISO 7816 method. A large file is really composed of pointers into the hidden media area that are actually outside the virtual smart card. However, to read and write the data in this large file, READ BINARY and UPDATE BINARY commands have their CLA bit set to 1 and contain a data part with a TLV that can address up to 128 bytes of address space into an additional SP data area. This means that all the functionality of the virtual smart card is available in the file system and individual files can reach many terabytes in size (effectively unlimited).

The final special EF file type is employed to protect sensitive firmware routines that may compromise the security of the disc drives. These are in the Administrative SP since they pertain to the drive as a whole. This in effect can be employed to require a PIN or cryptographic proof to gain access to a non-secure resource such as uploading firmware to a drive or putting the drive in diagnostics mode.

The Card Operating System (COS) essentially is an implementation of a standards-compliant traditional smart card operating system for managing multiple virtual smart cards on a disc drive. The COS supports multiple individual virtual smart cards, all of which are stored in a portion of the disc drive not available to normal disc drive operations (read and write commands). The COS includes the following components:
Input/output
File system
Command processing
Security architecture
Issuance protocol

FIG. 5 shows the basic structure and location of various portions of software used with trusted drive functions. Security and trusted drive functions are generated by various applications, either directly or indirectly as a result of user actions. The application may call the CSP, PKCS#11, or it may directly call APDUs (Application Protocol Data Units) for direct trusted drive operations. The APDUs are transmitted to the disc drive over the standard disc drive interfaces. The actual operation of the trusted drive functions occurs in the disc drive. Results from the trusted drive operations are returned by going backward over the same paths that created the request.

The COS is a smart card operating system that runs on the processor inside a disc drive. As illustrated in FIG. 6, there are two interfaces 130 and 132 between the COS 120 and the host 134 and disc storage 136. There is an external interface to the host device and an internal interface to the disc storage subsystem. The COS offers the host device a number of individual smart cards. An application running on the host device connects to and interacts with an individual smart card using industry-standard smart card commands called Application Protocol Data Units or APDUs.

Individual virtual smart cards are stored on the disc drive in a hidden area inaccessible to normal read/write commands. The COS retrieves individual virtual smart cards from the disc subsystem on demand from a host application and returns updated virtual smart cards to the disc storage subsystem after each application transaction.

The COS is a standards-compliant virtual smart card operating system inside a disc drive. The COS virtual smart card operating system is the realization on a disc drive of the virtual smart card operating system stored in the read-only memory of a traditional smart card. The operational data stored in the read/write memory of a traditional smart card, including the card's file system, is stored in the externally-inaccessible SP of the disc drive's storage media.

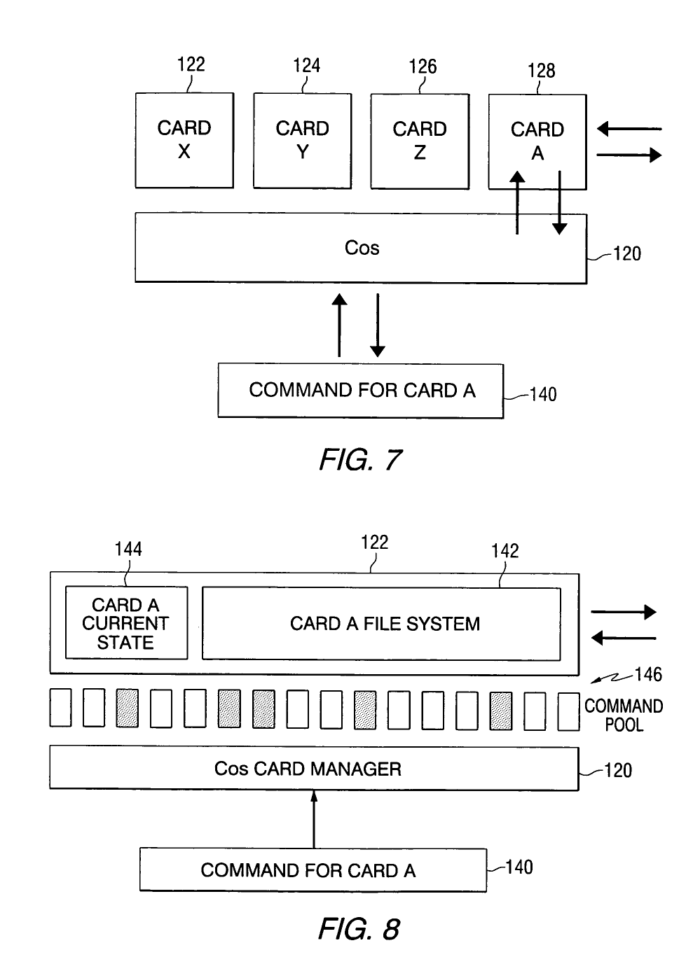

Because there is much more storage space available on the disc than in the read/write memory of a traditional smart card, the operational data for many different virtual smart cards can be stored in the disc drive's externally-inaccessible area. When a particular virtual smart card is being used, the operational data for that virtual smart card is read from the externally-inaccessible area into the drive processor where it is operated on by the COS operating system exactly like the operating system of a traditional smart card operates on the smart card's read/write memory. When the operation is completed, the operational data for the particular virtual smart card is written back to the externally-inaccessible area on the disc. FIG. 7 illustrates this process.

In FIG. 7, it can be seen that there is one operating COS 120 for all possible virtual smart cards 122, 124, 126, and 128. The virtual smart cards are addressed so that a given command 140 will execute on only one card, after it is appropriately authenticated.

In FIG. 8, it can be seen that each virtual smart card 122 contains both a file system 142 and information 144 about its current state. Depending on its current state, only some commands in a command pool 146 are applicable. A command 140 issued by an application will be honored if and only if the current security status satisfies the security attributes of the command and the referenced data.

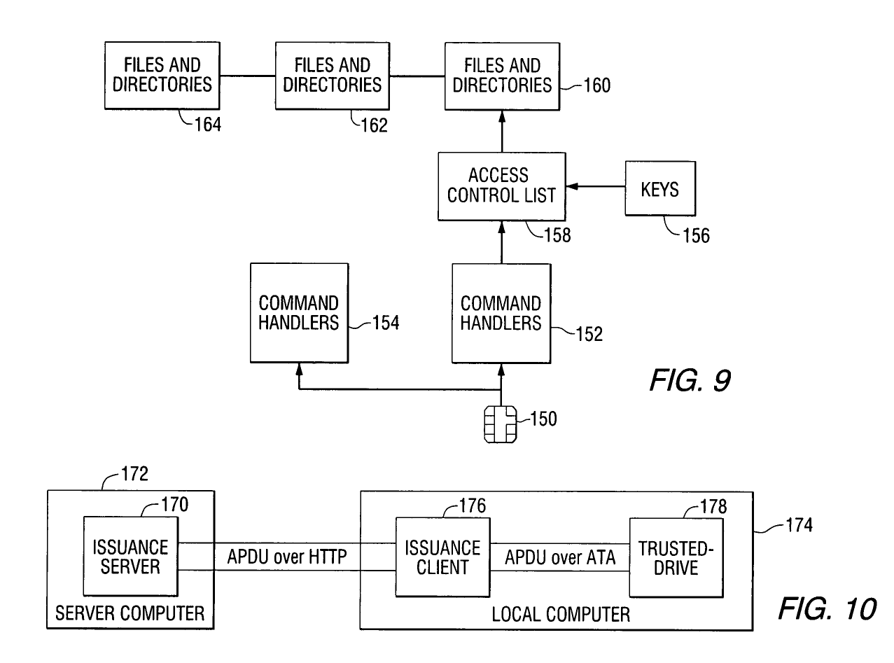

FIG. 9 shows that commands are not executed unless there are appropriately authenticated keys (authorized access control list) available for that card and function. A command 150 is input to a plurality of command handlers 152 and 154. The command key is then compared with a set of currently authenticated keys 156 using an access control list 158. Once the command has been authenticated, access is granted to the files and directories 160, 162 and 164.

To process one APDU from the host device, the COS receives an APDU from the host device into the Card Manager. If the card data for the card at which the APDU is directed is not in processor memory, the Card Manager brings it into processor memory. Then the Card Manager sets the Current Card context to the card data of the card addressed by the APDU and hands the APDU to the Command subsystem. The dispatch loop in the Command subsystem examines the first two bytes of the APDU and dispatches the APDU to the Command Handler for this CLA/INS pair. If there is no such handler, the dispatch loop returns an error condition status code to the Card Manager. The Command Handler for the APDU performs the command operation using the remaining data if any in the APDU, and returns a status code and optional response data to the Card Manager. In performing the command operation the Command Handler may place calls on the File System subsystem and the Cryptography subsystem. These calls may alter both the Card State data and the File System data. Upon return from its call to the Command subsystem, the Card Manager writes the card data out to disc storage if it was changed and sends the status code and optional response data back to the host device as the required response to the APDU.

The trusted drive is capable of hosting a number of virtual smart cards. Virtual smart cards are created through a process known as card issuance. The card issuance process includes an exchange of APDUs between the administrative virtual smart card on the trusted drive and an entity outside of the drive called the virtual smart card Issuer. The exchange of APDUs is known as the Issuance Protocol, and is illustrated in FIG. 10. An Issuance Server 170, located in a server computer 172 provides APDUs over HTTP to a local computer 174. The local computer includes an Issuance Client 176 that transmits the APDUs over ATA to the trusted drive 178.

In order to issue a virtual smart card on a trusted drive, a virtual smart card Issuer must properly compose and send the appropriate sequence of APDUs to the administrative virtual smart card. The nature of the Issuance Protocol is that each subsequent APDU depends on the response from the previous APDU. The Issuance Protocol dictates that portions of both the APDU commands and responses be cryptographically protected. Thus for a virtual smart card Issuer to be successful, the Issuer must have knowledge of the Issuance Protocol and must be privy to the cryptographic secrets required to successfully construct the APDU commands and analyze the APDU responses.

A virtual smart card Issuance Server is a web server that is specifically programmed to compose the APDU commands and analyze the APDU administrative virtual smart card responses that make up the Issuance Protocol. The Issuance Server contains all required cryptographic materials to issue virtual smart cards on the trusted drive. The Issuance Server is designed to work with its companion product, the Issuance Client.

The Issuance Client is a web client that serves as a proxy between the Issuance Server and a trusted drive, relaying command APDUs from the Server to the trusted drive and relaying response APDUs back from the trusted drive to the Server. The APDU exchange between the Issuance Server and the Issuance Client occurs over the hypertext transfer protocol (http), using a lightweight wrapper protocol. The Issuance Client initiates the Issuance Protocol by sending a message to the Issuance Server. The APDU exchange between the Issuance Client and the trusted drive occurs over the disc drive ATA interface.

Command APDUs are used for card issuance and would be proprietary for every issuer. The APDUs used in the trusted drive virtual smart card issuance are (in the order used):

1. ISSUE GET CHALLENGE

2. ISSUE GET SIGNATURE (and optional ISSUE GET SIGNATURE CONTINUE)

3. CHAIN KEY PUT

4. ISSUE EXTERNAL AUTHENTICATE

5. ISSUE CONFIRM

Messages relating to card operation have two structures: one for commands to the card, and the other for responses from the card. The APDUs describe these messages. These are referred to as the Command APDU and Response APDU, respectively.

All commands are executed sequentially, with no queuing. Although there can be multiple disc drives on a system, each disc drive operates the trusted drive functions independently under direct control of the host. All commands are for an individual disc drive.

The trusted drive utilizes the unique attributes of a disc drive or storage subsystem versus a traditional smart card. The fundamental differences are:

1. A disc drive has a much larger storage capacity.

a. A drive can support a large number of virtual smart card objects, each of which can be controlled by completely different agents.

b. Not only are there more smart card objects, but also the smart card objects are much larger than those on a traditional smart card.

c. Internal logging can be used for audits because the space is readily available for this security feature. Also, flash storage devices typical of traditional smart cards, will fail if written often, as is the case with logging.

2. A disc drive may not be easily removable.

a. Replication/backup mechanisms can be automated with no Host assist.

b. The management of the SPs can itself be protected, versus an ISO-716 smart card specification where the management is in the host.

3. A disc drive has a computer onboard.

a. The ISO 7816 specification also permits “memory cards” as well as “CPU cards” which means that keys and key operations may not be hidden.

On the other hand, if the disc drive computer or drive interface is swamped, the host interface handler may be required to take on functions as is permitted by less secure aspects of the ISO 7816 smart card specification.

There are several differences between traditional smart cards and virtual smart cards. Physically, a traditional smart card is usually just that—a card. Whereas, virtual smart cards are virtual. They are located in secure portions of a disc drive. A smart card is usually limited to around 64 KB of storage. A virtual smart card is essentially unlimited when compared to this number—it can be several megabytes or gigabytes. The storage on a smart card is stored in non-volatile memory; virtual smart card information is stored on the disc drive in a secure portion of the disc drive, unavailable to all standard operating system commands. A traditional smart card has only one smart card worth of information. A disc drive can have many virtual smart cards. In one example of a trusted drive, there are 125 user virtual smart cards.

There are a few very important differences in the information stored using virtual smart cards. Virtual smart cards, and the information in them, are not visible to standard host software. For example, Windows Explorer cannot see any of the files or names under any setting. Virtual smart cards are protected from standard disc drive commands, e.g., delete. This even includes a full disc drive format, where the virtual smart card data will be preserved even though all standard disc files will be destroyed.

The trusted drive can provide well-known security services that have well-understood value to the host. The host may be a user or a computer host somewhere in the storage hierarchy. The trusted drive concept can be used in any existing interface environment (PATA, SCSI, SAS, FC, SATA, 1394, MMC, USB, etc.) and yet be capable of delivering special security services. The services should have clear and unambiguous utility to existing trust infrastructures within Windows, Unix, Novell, Java, etc. In addition, the services should not be obtainable through other means. This is principally because of the large amount of hardened storage associated with the services.

The trusted drive can provide a horizontal security product embedded in a drive. Another example of a horizontal security in widespread use is the ISO 7816 smart card.

The trusted drive supports all of the following functionality:

1. Hiding private keys from unauthorized exposure.

2. Hiding private key operations from unauthorized exposure, since a key operation itself can expose a key.

3. Protecting cryptographic hashing, verifying, and signing operations from tampering.

4. Hiding arbitrary data from unauthorized exposure.

5. Providing hardened user/group/role authentication services to Windows 2000+ and all other OS platforms including Linux in common use.

6. Providing some limited bulk encryption/decryption services with hidden and protected keys.

7. Providing encryption/decryption services compatible with the digital rights management.

8. All hidden and/or tamper resistant services may be logged with specific authorization required to view the logs.

9. Providing replication/backup services for the other trusted drive services.

10. Providing Public Key Infrastructure support through a versatile keystore mechanism.

11. Providing specific public key authorization to create (or delete) branded services on a trusted drive.

Every virtual smart card can exist in two fundamental states: as an uninstantiated or virtual smart card template, and as an issued instantiated virtual smart card. Applications that use the trusted drive can select among the templates and issue as many as they desire to instantiate within disc space limitations. The virtual smart cards are instantiated in a contiguous series of logical hidden blocks on the drive. The controller then protects those blocks from any further formatting and from any reading aside from the virtual smart card mechanisms. When a virtual smart card is instantiated, it occupies a fixed, non-varying, contiguous, sequence of logical blocks on the drive.

Every virtual smart card is seen as a completely atomistic, stand-alone, entity. It is possible to take any virtual smart card and move it as a set of contiguous blocks on the drive. This makes actions such as replication and backup relatively straightforward. The virtual smart card implementation also preserves the notion that different application providers may reliably own different virtual smart cards without fearing that data can leak between these providers.

Every virtual smart card is atomistic as well in having stand-alone access control for user authorization. A large number of users may be authorized for fine grained reading and writing of record-oriented persistent data, for cryptographic operations that hide keys and key operations, and for various other special methods defined by a particular virtual smart card template.

Like traditional smart cards, virtual smart cards are issued by the manufacturer and personalized by the application provider. However, unlike traditional smart cards, issuance is a logical operation, not a physical operation. The manufacturer in this case may delegate issuance to a trusted partner. Issuance selects a template for instantiation and personalization fills the basic template with application specific files, keys, and authentication and authorization logic (ACLs).

There can be several basic virtual smart card types associated with the ISO-based release. One type of virtual smart card is an administrative virtual smart card (Admin virtual smart card corresponding to the administrative security partition). This is the only virtual smart card that controls other virtual smart cards, and it controls information on all the other virtual smart cards on a trusted drive. There is only one Admin virtual smart card on a drive. It is also the first virtual smart card set-up. On set-up, the Admin virtual smart card will generate its own pair of RSA public-private key pairs, one for signing and one for encrypting (or, as Microsoft would call them, a Signing Key Pair and an Exchange Key Pair). The drive manufacturer will then sign the Admin virtual smart card's public keys to prove that these keys came from an Admin virtual smart card on a trusted drive. From then on out, any key pair generated within a trusted drive can be signed and proven to be from such a drive.

A base virtual smart card is the root of the template class hierarchy. An admin virtual smart card is a subclass of the base virtual smart card. The base virtual smart card has certain basic attributes and methods that will be associated with all other virtual smart cards. It is possible to instantiate a base virtual smart card as a simple secure container.

A default crypto virtual smart card provides methods to support a default Microsoft Cryptographic Service Provider (MS CSP/CAPI) or a PKCS#11 Cryptoki. While all virtual smart cards provide the same cryptographic functionality, and thereby a CSP or PKCS#11 can be defined for them, the default Crypto virtual smart card provides a default CSP/PKCS#11 as defined in MS Windows and typical Linux applications without any Smart Card authentication controls set on the use of these functions. It is anticipated that most application providers will want to put authentication controls on the use of the cryptographic functions, and for this, they will use their own instantiation of a Base virtual smart card.

This invention can be implemented using template virtual smart cards that individualize types of smart cards that are available from the storage device.

A public key storage partition can be made available to the virtual smart card commands associated with the use of public keys. A public-private key cache can be made available to the virtual smart card commands that request new public-private key pairs on behalf of a smart card.

Specialized smart card files or objects can be implemented that may greatly exceed the address range provided by files or objects in the basic smart card command set. Scripting capability may be either drawn from existing smart card standards, such as JavaCard, or developed specially for this new class of smart cards.

Virtual smart cards can provide control over other internal storage device capabilities. This includes but is not limited to: drive locking that provides more versatile control of the ATA drive locking service including familiar password control but also optional control by cryptographic proof; whole drive encryption of all the data on the storage device, or encryption of specific files or objects on the storage device; bulk encryption services that may be provided by specialized hardware controlled by smart card commands on the storage device; control of encryption to partitions on the storage unit that are not strictly part of the smart card file system but can be referenced by link files in it; and control of serial ports and other communication ports on the storage device.

Virtual smart cards can also provide storage device electronic identification capability. Currently disc drives, for example, universally have a serial number and manufacturer name that can be read through the interface. Each virtual smart card on the storage device can have an identification and prove their validity through cryptographic proof using methods well-known for smart cards. The administration card on the storage device may optionally prove the identity of the entire device.

Virtual smart card commands may be interpreted directly by the processor in the storage device, or may be interpreted by a command translation service in the platform host or another location. In this case, the commands actually traversing the physical interface may be as described above, or another set of similarly capable commands.

Virtual smart cards can provide the capability to issue and personalize new smart cards on the storage device. Issuance and personalization are terms of art in the smart card community and refer to the creation of the physical smart card (issuance), and the creation of the application or applications on the physical smart card (personalization). Well-known standards exist that define a secure transition from the issuance, or new card, state and the personalization state that typically require a transfer key. In the present invention, issuance refers to the creation of a new smart card on the storage device either in a new partition or an existing reserved one, optionally using a defined card-type template. Personalization, in accordance with smart card standards, refers to the installation of the application specifics for the smart card possibly requiring a transfer key, as well as the installation of the corresponding platform host application. The present invention anticipates that card-by-card issuance and personalization may be performed at manufacture or anytime in the life cycle of the storage device.

Virtual smart cards can provide the capability to reset a card to the issuance state or initial personalized state, to suspend the action of the card, or to delete a card. The control over the access to the right to reset, suspend, or delete can be provided by smart card commands. A table of the smart cards and optionally other security partitions, as taught in U.S. Patent Publication No. 2003/0023867 A1, on the storage device, including but not limited to their state as active or suspended (and possibly failed) is a readable file table, or object on the Administration card. This table may also provide information about the number of available cards that can be further created.

Two additional file extensions are added: a /dev extension and a /xf extension. The /dev extension allows control over storage device hardware resources or other firmware resources on a drive. For example, a /dev extension may exist for enabling or disabling the normal read/write operations of the storage device. Another /dev extension may exist for setting the encryption keys for full disk or partial disk encryption. Yet another /dev extension may control access to the diagnostic serial port on the storage device. The /xf extended file extension allows for files that are pointers to additional SP storage space that would otherwise not be addressable within a 64 KB address space. Thus the invention allows the use of ISO 7816 smart card interfaces to control features on drives and to extend the virtual smart card to the entire SP data space.

Whereas particular embodiments of the invention have been described herein for the purpose of illustrating the invention and not for the purpose of limiting the same, it can be appreciated by those of ordinary skill in the art that numerous variations of the details, materials and arrangement of parts may be made within the principle and scope of the invention without departing from the invention as described in the appended claims.

What is claimed is:

1. An apparatus comprising:
a data storage device including a plurality of virtual smart cards in a plurality of security partitions; and
a controller including a card operating system for controlling access to the smart cards.

2. The apparatus of claim 1, wherein one of the virtual smart cards is an administrative virtual smart card.

3. The apparatus of claim 1, wherein each of the virtual smart cards includes at least one authority record and at least one data set associated with said authority record.

4. The apparatus of claim 1, wherein each of the virtual smart cards limits access to at least a portion of the data storage device by a host computer.

5. The apparatus of claim 1, wherein the storage device is configured in accordance with a protocol selected from the group consisting of ATA protocol and SCSI protocol.

6. The apparatus of claim 1, wherein one of the security partitions is a public key security partition.

7. The apparatus of claim 1, wherein at least one of the virtual smart cards is a template virtual smart card.

8. The apparatus of claim 1, wherein at least one of the virtual smart cards includes a file extension allowing control over storage device hardware resources or other firmware resources on a drive.

9. The apparatus of claim 8, wherein storage device hardware resources or other firmware resources enable or disable normal read/write operations of the storage device; set encryption keys for full disk or partial disk encryption; or control access to diagnostic serial port on the storage device.

10. The apparatus of claim 1, wherein at least one of the virtual smart cards includes a file extension, which allows for files that are pointers to additional storage space.

11. The apparatus of claim 1, wherein at least one of the virtual smart cards includes scripting capability.

12. The apparatus of claim 1, wherein at least one of the virtual smart cards controls storage device capabilities including at least one of:
drive locking, whole disc encryption, bulk encryption, encryption to partitions, and communication port operation.

13. The apparatus of claim 1, wherein at least one of the virtual smart cards includes identification information.

14. The apparatus of claim 1, wherein the virtual smart cards are issued and personalized.

15. The apparatus of claim 1, wherein the virtual smart cards can be reset, suspended or deleted.

16. The apparatus of claim 1, wherein at least one of the security partitions includes a master authority record.

17. The apparatus of claim 16, wherein the master authority record includes a public-private key pair for authenticating data originating from at least one of the security partitions.

18. The apparatus of claim 17, wherein the master authority record includes a second public-private key pair for ensuring data can only be sent to at least one of the security partitions.

19. The apparatus of claim 17, wherein the master authority record includes at least one nonce.

20. The apparatus of claim 1, wherein each of the virtual smart cards occupies a contiguous sequence of logical blocks on a data storage medium.
